(19) United States
(12) Patent Application Publication
(10) Pub. No.: US 2004/0070157 A1
(43) Pub. Date: Apr. 15, 2004

(54) Trailer

(76) Inventor: Arthur D. Boice, Lake Katrine, NY (US)

Correspondence Address: JOHN MAIER, III., 666 AARON COURT, KINGSTON, NY, 12401, US

(21) Appl. No.: 10/269,474

(22) Filed: Oct. 11, 2002

(51) Int. Cl. B60R 17/00

(52) U.S. Cl. 280/6.15

(57) ABSTRACT

A trailer for carrying cargo and also towing a motor vehicle. A cradle for retaining the front wheels of a motor vehicle is located at the rear of the trailer and the majority of the length of the trailer has a platform for carrying cargo. Means including air cushions is used to drop the trailer close to the ground level to load both the motor vehicle and the cargo.

### BACKGROUND OF THE INVENTION

1. Field of the Invention

This invention relates to trailers and more specifically relates to a trailer for transporting cargo of a wide variety but most specifically recreational equipment such as motorcycles, snowmobiles and four wheelers while also being capable of towing a motor vehicle.

2. Prior Art and Objects

The use of recreational vehicles, commonly referred to as RVs, has become increasingly popular. Families traveling and vacationing with a RV, frequently desire to use a variety of recreational equipment, including but not limited to motorcycles, snowmobiles and four wheelers. It is also a very common practice to take a motor vehicle on a trip with a RV so as to have transportation while the RV is parked. Motor vehicles are commonly towed behind the RV and since a majority of motor vehicles have front wheel drive, the front wheels of the motor vehicle are placed in a cradle mounted on wheels that is towed behind the RV. along with a RV.

There is one device currently known that begins to answer the need to take recreational equipment A motorcycle carrier that mounts on the rear of an RV has been produced which effectively permits the carrying of one motorcycle while still permitting the towing of a cradle on which the front wheels of motor vehicle are mounted. This device has been most popular but the amount and type of recreational equipment that can be carried is still limited. A need exists for a device that can be used with a RV and possibly another towing vehicle, that can transport a variety of recreational equipment, sufficient in amount for use by an entire family as well as offering a variety of equipment that also provides a cradle for the towing of a motor vehicle. It is also important that any such device provide a reasonably smooth ride to prevent damage to the recreational equipment as well as to any motor vehicle being towed. The cradles currently available do not provide any cushioned suspension which may result in damage to the motor vehicle due to bouncing.

It is essential that a trailer that both transports recreational equipment and tows a motor vehicle have a cushion suspension. It is also of the greatest importance that the trailer be easily loaded with both the recreational equipment as well as the motor vehicle being towed.

It should be understood that although this invention provides a trailer for use with an RV to carry recreational equipment while also towing a motor vehicle, it has a wide diversity of other applications. By way of illustration and not by way of limitation, the trailer in accordance with this invention may be towed by a truck and provide additional cargo space while permitting the towing of a motor vehicle of some type. Such usage could be invaluable to a construction contractor. Any situation where a trailer is needed to carry cargo and where inclusion of an additional motor vehicle is desirable, this trailer has application.

In the past, various patents have shown trailers for transporting motor vehicles and recreational equipment of one type or another.

The Smidler Patent, U.S. Pat. No. 5,752,798, teaches a trailer for carrying motor vehicles. In order to permit loading of the trailer, an air cushion is provided which permits the rear of the trailer to be dropped sufficiently close to the ground to permit easier loading of the motor vehicles into the trailer.

The Wellman Patent, U.S. Pat. No. 5,810,544, is for a trailer for specifically intended for transporting motorcycles. Cantilevered arms are used to mount the wheels. The wheels are mounted on a perimeter frame. A lever member tilts on the perimeter frame and a load platform is mounted to pivot at the rear of the lever member. A cable system connected to front of the load platform and the perimeter frame pulls the load platform and the perimeter frame together for transit. With the cable system let out, the load platform drops to the ground.

The Kallstrom Patent, U.S. Pat. No. 6,068,278 teaches a two-wheel trailer for motorcycle transportation. By use of air shocks, the trailer tilts down at its end to permit a motorcycle to be wheeled onto the trailer.

The Stringer Patent, U.S. Pat. No. 6,273,435 is for a two-wheel trailer which does not tilt but does drop toward the ground for loading and raises to above the wheel hubs for travel. The trailer and side support structure are forced backward and forward by an actuation system and cams and cam followers move the trailer bed up and down as it is moved back and forth.

At this time, a trailer is not available to both carry cargo including recreational equipment while also towing a motor vehicle and while also providing ready loading of both the cargo including recreational equipment and the motor vehicle.

Therefore, it is an object of this invention to provide a trailer for carry cargo such as a variety of recreational equipment while also towing a motor vehicle.

It is another object of this invention to provide a trailer that is suspended and which provides a cargo area and also provides a cradle for towing a motor vehicle.

It is another object of this invention to provide a trailer which drops down to provide ready access for mounting a motor vehicle.

It is another object of this invention to provide a trailer which provides a system for readily loading cargo onto the trailer.

It is another object of the present invention to provide a combination trailer and motor vehicle towing device that is both durable and can be comparatively inexpensively constructed.

These and other objects will be apparent to those skilled in the art when read in conjunction with the annexed description and drawings.

### SUMMARY OF THE INVENTION

A trailer is provided for carrying cargo and for towing a motor vehicle. The trailer a frame and the frame has a front and a rear. A base member is mounted on the frame to pivot downwardly from the frame. An axle is mounted on the base member. Wheels are mounted to rotate on the ends of the axle. Means which include an air cushion which is inflatable are provided to pivot the base member to and from the frame to raise and lower the frame. A draw bar is connected to the front of the frame. A platform is mounted on the frame that extends from the front to the wheels. The platform is extends from the front a major portion of the distance from the front to the rear. A cradle is mounted at the rear of the frame to hold the front wheels of the motor vehicle.

### DESCRIPTION OF THE DRAWINGS

FIG. 1 is a pictorial view of the trailer viewed from the right front of the trailer showing the tow bar, the cargo area and the motor vehicle trailer mounted on the axis and specifically showing the removable ramp for easy access to the cargo area.

FIG. 2 is a pictorial view from outside the trailer showing the mounting arm rotated away from the frame and showing the arch into which the axle fits when the mounting arm and the frame are bought together.

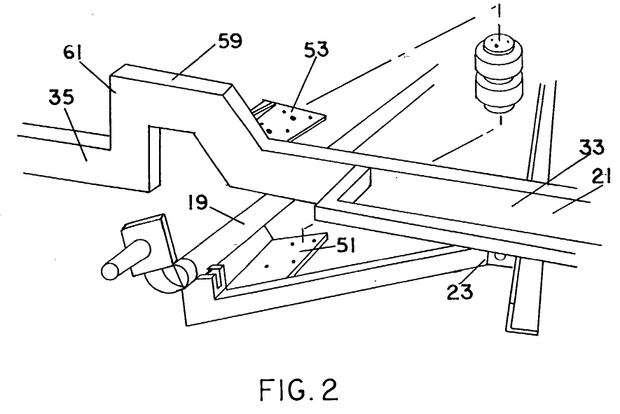

FIG. 3 is a pictorial view similar to FIG. 2 but with the mounting arm rotated against the frame with the axle in the arch.

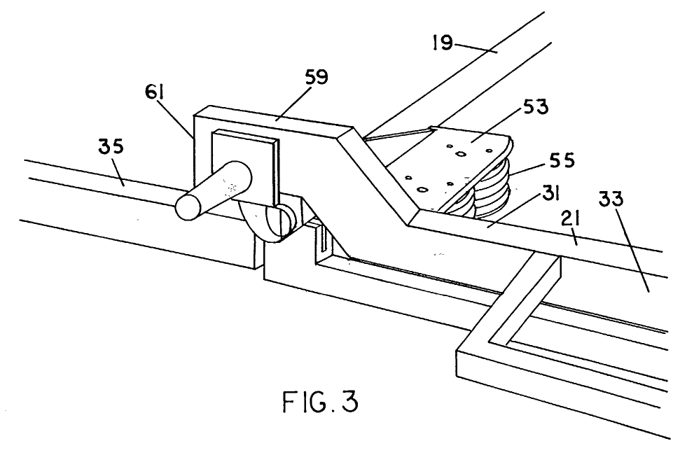

FIG. 4 is a pictorial view of the mounting member with the axle mounted thereon and the frame with the mounting member rotated away from the frame and showing the plates mounted on the frame and the mounting member and the air cushion that is located between the two plates.

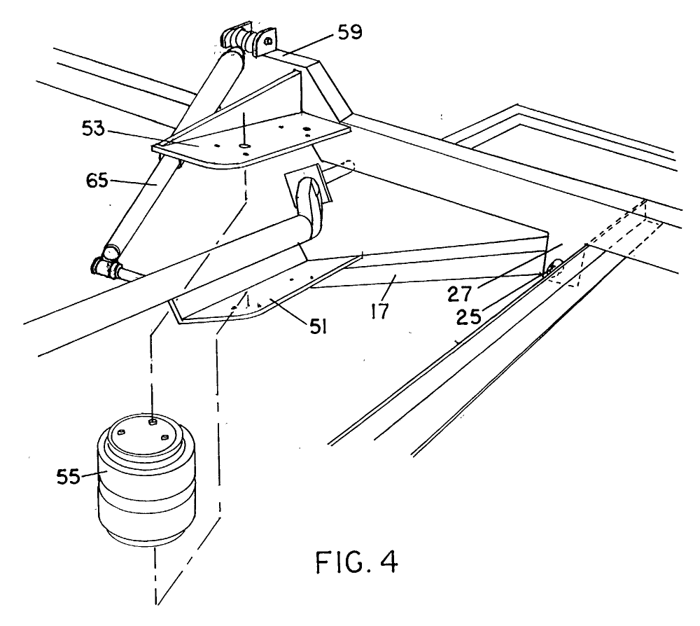

FIG. 5 is a pictorial view similar to FIG. 4 but with the mounting member rotated against the frame with the air bags compressed between the plates.

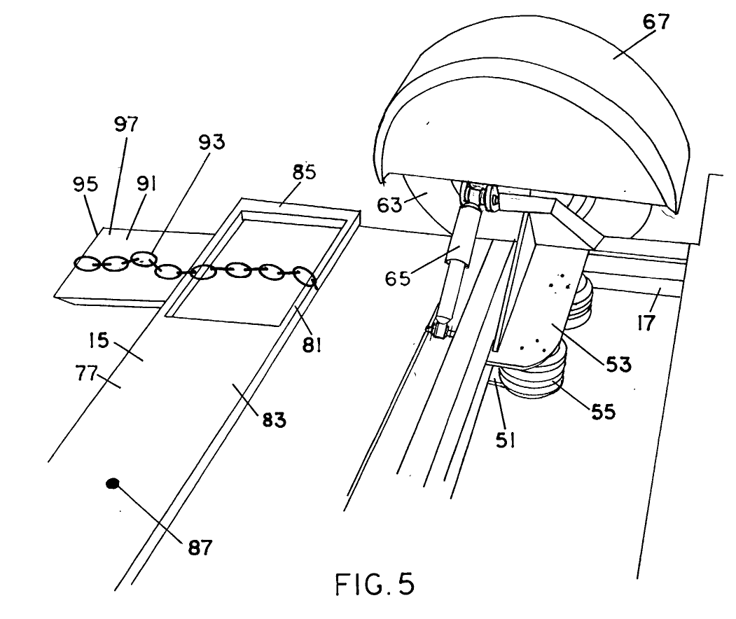

FIG. 6 is a pictorial view of the trailer from the rear showing the motor vehicle trailer at the rear of the trailer behind the axle and the cargo area forward of the axle.

FIG. 7 is plan view of the trailer with the platform and cradle removed showing the structure of the trailer.

### DETAILED DESCRIPTION OF THE NUMERALS

| NUMERAL | DESCRIPTION |
|---|---|
| 11 | Tow Bar Assembly |
| 13 | Cargo Area |
| 15 | Cradle Area |
| 17 | Mounting Member |
| 19 | Axle |
| 21 | Frame |
| 23 | End |
| 25 | Pivot Pin |
| 27 | Pair of Straps |
| 29 | Rear |
| 31 | Side Members |
| 33 | Front Member |
| 35 | Rear Section |
| 37 | Front Member |
| 39 | Front |
| 41 | Rear Member |
| 43 | Front Inner Member |
| 45 | Rear Inner Member |
| 47 | Lower Center Member |
| 49 | Opening |
| 51 | Lower Plates |
| 53 | Upper Plates |
| 55 | Air Cushions |
| 57 | Arch |
| 59 | Short Member |
| 61 | Vertical Member |
| 63 | Wheels |
| 65 | Shock Absorbers |
| 67 | Fenders |
| 69 | Platform |
| 71 | Ramps |
| 72 | Brackets |
| 73 | Channels |
| 75 | Clips |
| 76 | Slots |
| 77 | Upper Cradle |
| 79 | Upper Rear Member |
| 81 | Upper Inner Member |
| 83 | Upper Center Member |
| 85 | Upper Side Member |
| 87 | Opening |
| 89 | Pin |
| 91 | Rear Ramps |
| 93 | Pair of Chains |
| 95 | Lower Edge |
| 97 | Flaps |
| 99 | Latch |
| 101 | Draw Bar |
| 103 | Two Support Members |
| 105 | Air Compressor |

### DETAILED DESCRIPTION OF THE PREFERRED EMBODIMENT

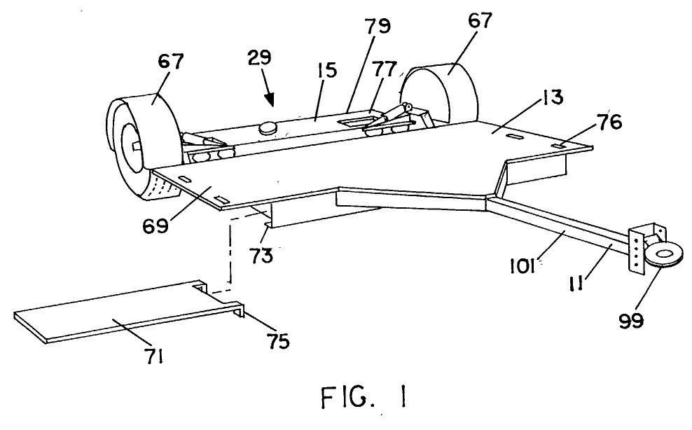

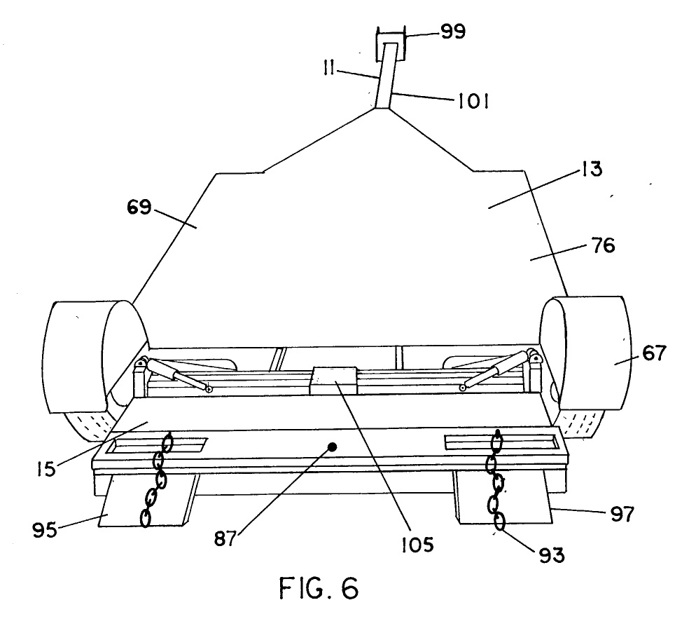

As seen in FIG. 1, the trailer in accordance with this invention includes a towing bar assembly 11, a cargo area 13 and a cradle area 15 for towing a front-wheel drive motor vehicle. As is quite apparent from FIG. 1 and FIG. 6, that the cargo area 13 covers the major portion of the trailer and the cradle area 15 located most remote from the towing assembly 11 is a very minor portion of the trailer.

The trailer is mounted on a mounting member 17 on which an axle 19 is secured. A frame 21 is mounted above the mounting member 17. The axle 19 is secured to the mounting member 17. The mounting member 17 is connected to the frame 21 at one end 23 to pivot on the frame 21 by means of a pivot pin 25 secured within a pair of straps 27 affixed to the frame 21. The end 23 of the mounted member 17 that is mounted on the frame 21 to pivot is the end 23 of the mounting member 17 closest to the tow bar assembly 11 and the mounting member 17 extends from there toward the rear 29 of the trailer where the cradle area 15 for towing a motor vehicle is located.

The frame 21 has two generally parallel side members 31, each side member 31 of the frame including two sections, namely a front section 33 adjacent the towing bar assembly 11 and a rear section 35 adjacent to the cradle area 15. The frame 21 further includes a front member 37 located at the front 39 of the trailer. The front member 37 is generally located at right angles to the two side members 31 and the front member 39 connects the two side members 31 together. A rear member 41 is located at the rear 29 of the trailer which is the location of the cradle area 15 of the trailer and the rear member 41 is also secured at right angles to the two side members 31. The frame 21 also has a front inner member 43 which is secured to both side members 31 of the frame 21 and the front inner member43 is spaced from but located toward the front member 37. The front inner member 43 is generally parallel to both the front member 37 and the rear member 41. A inner rear member 45 is also secured to the two side members 31 of the frame 21 and is located toward but in a spaced relationship to the rear member 41 and the inner rear member 45 is generally parallel to the front member 37, the rear member 39 and the front inner member 43. An lower center member 47 is located midway between the two side members 31 of the frame 21and extends between the rear member 41 and the inner rear member 45. The lower center member 47 is generally parallel to the two side members 31. An opening 49 is located centrally through the lower center member 47.

Lower plates 51 are mounted on each mounting member 17 and on the axle 19. Directly above the lower plates 51 and connected to the frame 21 are a pair of upper plates 53. Between each set of upper plates 53 and lower plates 51 are at least one but preferably a pair of air cushions 55. When the air cushions 55 are deflated, the upper plates 53 and the lower plates 51 are forced toward one another by the weight of the trailer.

Both side members 31 of the frame 21 are constructed with a arch 57. The arch 57 is located at the junction point of the front sections 33 and the rear sections 35. At the point where the axle 19 is located, the front section 33 extends upwardly and then continues along a short member 59 parallel to but above the rear section 35. A vertical member 61 is secured to both the front section 33 and the rear section 35 to complete the arch 57 and secure each front section 33 to its respective rear section 35. In this way the arch 57 is formed in the side members 31. The rear section 35 extends from the arch generally parallel with the front section 33 but slightly lower than the front section 33 extends from the front member 33 to the arch 57. The axle 19 is situated in the arch 59 when the air cushions 55 are deflated.

As the air cushions 55 are inflated, both set of lower plates 51 are forced apart and the axle 19 having wheels 63 mounted on it is forced downwardly away from the frame 21 thereby moving the frame 21 upwardly away from the ground. However, with the air cushions 55 deflated, the frame 21 is close to the ground. This, of course, permits ready loading of cargo onto the cargo area 13 . A pair of shock absorbers 65 are mounted on an angle to the pivot at the top of the short member 59 of the side members 31 and are secured to rotate at their lower ends on the axle 19. As seen in FIG. 1 and FIG. 6, fenders 67 are mounted over the wheels 63.

The cargo area 13 is covered by a platform 69. The platform 69 would include a plurality of openings (not shown) to permi9t a wide variety of places to connect tie downs (not shown) used to secure cargo to the platform 69. The platform 69 extends from the tow bar assembly 11 to the wheels 63. Since the axle19 and thus the wheels 63 are located immediately adjacent the cradle area 15 toward the rear 29 of the trailer, the rear cradle area 15 is substantially smaller than the cargo area 13. The major portion of the distance from the front 39 pf the trailer to the rear29 of the trailer is cargo area 13.

To permit easy access for loading cargo including equipment such as snowmobiles, motorcycles and four wheelers, ramps 71 are provided. The ramps 71 are stored in channels 73 under the platform 69. With the air cushions 55 deflated, the ramps 71 are slid out and are affixed by means of clips 75 to the platform 69 of the cargo area 13. Slots 76 are located along the edge of the platform 69 to retain the clips 75. It is essential that when the ramps 71 are not in use that the ramps 71 be positively secured by any suitable means within the channels 73.

The cradle area 15 has an upper cradle 77 over the rear member 41 and the inner rear member 45 and the lower center member 47. The upper cradle 77 has an upper rear member 79 and an upper inner rear member 81 and an upper center member 83. The upper cradle 77 also has a pair of upper side members 85 that extend between the ends of the upper rear member 79 and the upper inner rear member 81. An opening 87 in the upper center member 79 of the upper cradle 77, is located directly over the opening 49 in the lower center member 47 of the frame 21. A pin 89 is located in the openings 49,87 in the lower center member 47 and in the upper center member 83 to permit the upper cradle 77 to pivot on the frame 21. This permits the upper cradle 77 to rotate to a limited degree when the trailer has a motor vehicle mounted in the upper cradle 77 and the trailer is turning. In this way the pull on the motor vehicle from a turn is slightly relieved.

Rear ramps 91 are mounted on the rear member 41 and provide an incline readily to drive a motor vehicle onto the upper cradle 77. A pair of chains 93 extend from the from the upper cradle 77 to the lower edge 95 of the flaps 97. These chains 93 limit the degree to which the upper cradle 77 can rotate on the frame 21. The wheels of the motor vehicle are strapped into the upper cradle 77 in the same manner as is now widely used.

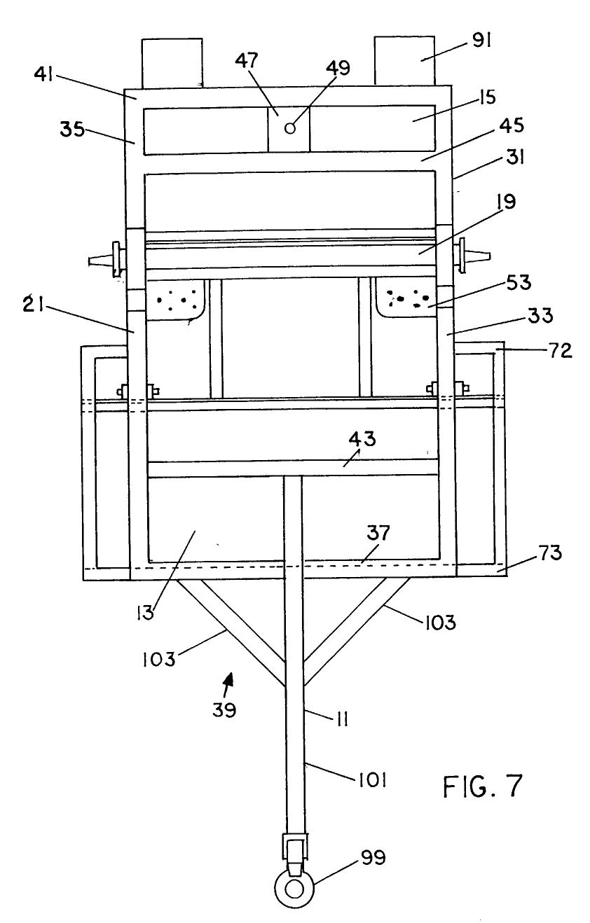

As best seen in FIG. 7, the tow bar assembly 11 includes a latch 99, a draw bar 101 and two support members 103. The draw bar 101 extends through the front member 37 to the inner front member 43. The support members 103 extend from around the center of the draw bar 101 at an angle to the front member 37 and are secured to both the draw bar 101 at an angle to the front member 37 and are secured to both the draw bar 101 and to the front section 37. The support members 103 provide rigidity to the draw bar 101 and prevent the draw bar 101 from bending. The hitch 99 at the forward end of the draw bar 101 forms a positive lock on the towing vehicle as the weight of the motor vehicle causes the hitch 99 to pull up on the towing vehicle.

A source of compressed air, preferably an air compressor 105, is located forward of the upper cradle 77. The air compressor 105 may be powered by a battery (not shown) or by the power supply of the towing vehicle.

It is to be understood that the drawings and description matter are in all cases to be interpreted as merely illustrative of the principles of the invention, rather than as limiting the same in any way, since it is contemplated that various changes may be made in various elements to achieve like results without departing from the spirit of the invention or the scope of the appended claims.

I claim:

1. A trailer for carrying cargo and for towing a motor vehicle, said trailer comprising:
a frame, the frame having a front and a rear;
a pair of mounting members mounted on the frame to pivot downwardly from the frame;
an axle having two ends mounted on the mounting member;
wheels mounted to rotate on the ends of the axle;
means including an air cushion which is inflatable to pivot the mounting member to and from the frame to raise and lower the frame;
a draw bar connected to the front end of the frame;
a platform mounted on the frame that extends from the front to the wheels, the platform extending from the front a major portion of the distance from the front to the rear; and
a cradle mounted on the rear end of the frame to hold the front wheels of a motor vehicle.

2. A trailer according to claim 1 wherein the frame includes two side members, a front member extending between the two side members at the front and a rear member extending between the two side members at the rear, each side member having an arch formed in it toward the rear.

3. A trailer according to claim 1 wherein each mounting member extends from the frame to the rear of the frame.

4. A trailer according to claim 1 wherein the axle is mounted on the mounting members remote from where the mounting members are mounted to pivot on the frame.

5. A trailer according to claim 1 wherein the means including an air cushion includes two pairs of plates, each pair of plates being in a spaced relationship to one another, one of each pair of plates being affixed to the axle with the other plate being affixed to the frame.

6. A trailer according to claim 1 wherein the cradle includes an upper cradle mounted to pivot on the frame.

7. A trailer for carrying cargo and for towing a motor vehicle, said trailer comprising:
a frame having a front and a rear, the frame having two side members, a front member extending between the two side members at the front and a rear member extending between the two side members at the rear;
a pair of mounting members mounted on the side members, each mounting member having two ends, one end being mounted to pivot on a side member and each mounting member extending to the rear from the end mounted to pivot on the side members;
an axle having two ends mounted on the ends of the mounting members opposite from the ends of the mounting members mounted to pivot on the side members;
wheels mounted to rotate on the ends of the axle;
two pairs of plates, each pair of plates being in a spaced relationship to one another, one plate of each pair of plates being affixed to the axle with the other plate being affixed to the frame;
at least one air cushion located between each pair of plates;
means to inflate and deflate the air cushions;
a platform mounted on the frame; and
an upper cradle located on the frame at the rear.

8. A trailer according to claim 7 wherein each side member further includes an arch.

9. A trailer according to claim 7 wherein each side member further includes an arch and the frame includes an inner rear member extending between the side members in a spaced relationship to the rear member and a lower center member extending between the rear member and the inner rear member.

10. A trailer according to claim 7 wherein each side member further includes an arch and the frame includes an inner rear member extending between the side members in a spaced relationship to the rear member and a lower center member extending between the rear member and the inner rear member, the lower center member having an opening centrally located in it; and
a pivot pin is located in the opening in the lower center member and in the upper cradle to pivot the upper cradle on the frame.

11. A trailer according to claim 7 further including a pair of rear ramps extending from the upper cradle.

12. A trailer according to claim 7 further including a pair of side ramps to be connected to the platform.

13. A trailer according to claim 7 further including:
a pair of rear ramps extending from the upper cradle; and
a pair of side ramps to be connected to the platform.

14. A trailer for carrying cargo and for towing a motor vehicle, said trailer comprising:
a frame having a front and a rear, the frame having two side members, a front member extending between the two side members at the front and a rear member extending between the two side members at the rear, said frame further including an inner rear member extending between the side members in a spaced relationship to the rear member and a lower center member extending between the rear member and the inner rear member generally midway between the side members, the lower center member having an opening centrally located in it;
a pair of mounting members mounted on the side members, each mounting member having two ends, one end being mounted to pivot on a side member and each mounting member extending to the rear from the end mounted to pivot on the frame;
an axle having two ends mounted on the ends of the mounting members opposite from the ends of the mounting members mounted to pivot on the side members;
wheels mounted to rotate on the ends of the axle;
two pairs of plates, each pair of plates being in a spaced relationship to one another, one plate of each pair of plates being affixed to the axle with the other plate being affixed to the frame;
at least one air cushion located between each pair of plates;
means to inflate and deflate the air cushions;
a platform mounted on the frame, the platform extending from the front a major portion of the distance from the front to the rear;
an upper cradle including an upper rear member and an upper inner rear member, the upper rear member and the upper inner rear member being generally parallel to one another and each having two ends, the upper cradle further including a pair of upper side members connecting the ends of the upper rear member and the upper inner member, an upper center member being located generally midway between the upper side members and extending between the upper rear member and the upper inner rear member, the upper center member having an opening centrally located in it;
a pivot pin located in the opening in the lower center member and in the upper center member to pivot the upper cradle on the frame; and
means for supplying air under pressure to the air cushions.

15. A trailer according to claim 14 wherein each side member has an arch formed in it toward the rear.

16. A trailer according to claim 14 further including:
a pair of rear ramps extending from the upper cradle;
a pair of side ramps having clips for temporarily connecting the side ramps to the platform; and
channels secured to the frame beneath the platform for storage of the side ramps.
